(19) United States
(12) Patent Application Publication
(10) Pub. No.: US 2004/0117472 A1
(43) Pub. Date: Jun. 17, 2004

(54) Consultation service system, server, and consultation service terminal

(75) Inventor: Akira Masachika, Saitama (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/703,552

(22) Filed: Nov. 10, 2003

(30) Foreign Application Priority Data
Nov. 12, 2002 (JP) 328742/2002

(51) Int. Cl. G06F 15/173

(52) U.S. Cl. 709/223

(57) ABSTRACT

When a consultation subject screen and reference data are to be displayed on a single screen, the constitution of the screen becomes complicated. If auxiliary information is to be used, then the auxiliary information must be created, and the creation and distribution of the auxiliary information is expensive. Moreover, it takes a long time to search for the page which matches the displayed consultation subject screen and consult with a customer while referring to the required data. A consultation service system according to the present invention comprises a consultation service terminal for performing a consultation service with a customer, and a server which uses a link data table for linking the data comprised in the consultation subject screen which correspond to the consultation subject of the customer with auxiliary information for assisting the consultation service in order to create a virtual screen comprising the consultation subject screen and auxiliary information, and outputs an image of the virtual screen to the consultation service terminal.

### BACKGROUND OF THE INVENTION

1. Field of the Invention

The present invention relates to a system and related equipment for performing a consultation service with a customer smoothly by displaying to the customer appropriate images (including alphanumerical data) for the consultation subject of the customer.

2. Description of Related Art

Conventional terminal devices (to be referred to as “consultation service terminals” below) exist for performing a consultation service with a customer-smoothly by displaying to the customer screens corresponding to the consultation subject of the customer (to be referred to as “consultation subject screen” below) while the customer and a counselor on a service provider side converse. A window device (see, for example, paragraphs 0002 to 0004 and FIG. 19 of Japanese Unexamined Patent Application Publication 2001-112595) used in financial institutions such as a bank or consumer credit facility, transportation systems such as railroads and the aviation industry, distribution facilities such as supermarkets and department stores, and so on exists as one type of consultation service terminal.

A window device is a consultative interactive device disposed in the window of a bank or railroad, for example, and used to provide various services (for example, opening an account, creating a loan contract, and so on in a bank, or selling tickets and the like on a railroad) while a counselor on the service provider side interacts directly with the customer.

A conventional consultation service terminal is constituted such that one counselor can respond to one customer or one group of customers.

In recent years, however, the content of services in various fields has become more sophisticated, and hence when a conventional consultation service terminal is used, a single counselor may not be able to respond sufficiently. In the banking industry, for example, the content of a money loaning operation which is typically performed in a bank (for example, the type of loan and loan conditions, the amount, interest, method of repayment, contractual conditions, and so on) has diversified to the extent that normal commercial bank shave begun to provide fiduciary services. Moreover, services which are not typically provided by a bank, such as insurance, securities transactions, and so on have come to be provided. In order to accommodate this increased sophistication in service content, counselors are required to obtain a high level of knowledge and experience. In order for each counselor to gain a high level of knowledge and experience, however, high-level education programs must be provided to the counselors and a large amount of time must be invested. Moreover, there are limitations on and variations in the knowledge and experience that each counselor is able to gain. As a result, a single counselor may not be able to sufficiently respond to the consultation needs of a customer. Hence a problem arises in conventional consultation service terminals in that smooth consultation services sometimes cannot be implemented.

In response thereto, the present applicant attempted to develop a system (to be referred to as a “consultation service system” below) in which a supporter possessing specialist knowledge and experience is disposed in a remote location, and in which the supporter is capable of supporting a consultation service with a customer. This consultation service system is constituted by a server, a consultation service terminal, and a plurality of terminals for supporting the consultation service with the customer (to be referred to as “consultation service support terminals” below). When a counselor operating the consultation service terminal places a request for support, the server selects a consultation service support terminal that is being operated by a supporter who can provide appropriate support, and then connects the selected consultation service support terminal to the consultation service terminal. Thus the supporter provides support through the consultation service support terminal.

It was envisioned that in this consultation service system, the consultation service with the customer would be performed by displaying a consultation subject screen on the consultation service terminal and consultation service support terminal according to the following method.

That is, a consultation subject screen on which data to be referred to when explaining the consultation subject to the customer are noted is displayed on the consultation service terminal, and the counselor implements the consultation service while showing the consultation subject screen to the customer. According to this method, however, a large amount of data is displayed on the screen in small characters, and hence it takes a long time for the customer to read and understand the data. Moreover, data that cannot be shown to the customer (to be referred to as “confidential data” below) cannot be displayed on the screen, and hence when confidential data exist, auxiliary information in booklet form in which the confidential data and so on are noted must be provided separately, and the counselor must implement the consultation service while referring to this auxiliary information. In this case, the counselor has to search for the page which matches the consultation subject screen and provide explanation to the customer while referring to the confidential data, and hence a long time is required to implement the consultation. Alternatively, auxiliary information in booklet form is prepared separately instead of displaying a consultation subject screen on which the data to be referred to are not noted, and the counselor is forced to implement the consultation service while referring to the auxiliary information. Here, the counselor must search for the page which corresponds to the consultation subject screen and provide explanation to the customer while referring to the data to be referred to, and hence in this case also a long time is required to implement the consultation.

Further, an identical image to the image displayed on the consultation service terminal is displayed on the consultation service support terminal by causing the counselor to confirm this image with the supporter verbally, and thus the supporter provides explanation to the customer or counselor while referring to the booklet-form auxiliary information. In this case also, the supporter has to search for the page which matches the consultation subject screen and provide explanation to the customer while referring to the required data (confidential data, data to be referred to, and soon), and hence a long time is required to implement the consultation service.

Thus when a consultation subject screen and data to be referred to are displayed on a single screen, a large amount of data are displayed on the screen in small characters, and as a result a problem arises in that it takes a long time for the customer to read and understand the data (in other words, the constitution of the screen is complicated, and hence a long time is required for the customer to understand the data).

Further, when auxiliary information is used, a problem arises in that it is expensive to create and distribute the auxiliary information, and since explanation must be provided to the customer while referring to the required data after searching for the page which matches the displayed consultation subject screen, a long time is required to implement the consultation service (in other words, the customer is kept waiting).

### SUMMARY OF THE INVENTION

In order to solve the problems described above, an object of the present invention is to provide a consultation service system according to which auxiliary information can be displayed in a short amount of time and by a simple operation.

A consultation service system according to the present invention comprises a consultation service terminal for performing a consultation service with a customer, and a server which stores an application that can be operated by the consultation service terminal. In this constitution, the server executes an application on the basis of an operation performed on the consultation service terminal, and creates an image indicating the result of this execution. The image indicating the result of the execution of the application becomes an image on a virtual screen displayed by the consultation service terminal. The server uses a link data table for linking data comprised in a consultation subject screen which corresponds to the consultation subject of the customer with auxiliary information for assisting the consultation service in order to create a virtual screen comprising the consultation subject screen and the auxiliary information, and outputs an image of this virtual screen to the consultation service terminal.

In the consultation service system constituted in this manner, the server uses the link data table to create an image on the virtual screen which includes the consultation subject screen and the auxiliary information. In the case of data to be referred to by the customer, for example, these data are specified by the customer or a counselor, whereupon an image of the auxiliary information linked to these data is opened on the virtual screen, and thus the auxiliary information can be displayed on the terminal. As a result, the problem concerning that fact that when a consultation subject screen and reference data are displayed on a single screen, the screen constitution becomes complicated such that a large amount of time is required for the customer to understand the data can be solved. The problem concerning the fact that when auxiliary information is used, the creation and distribution of the auxiliary information is expensive and the customer is kept waiting can also be solved.

### BRIEF DESCRIPTION OF THE DRAWINGS

The foregoings and other objects, features and advantages of the present invention will be better understood from the following description taken in connection with the accompanying drawings, in which:

FIG. 1 is a view showing the constitution of a consultation service system according to the present invention;

FIG. 2 is a view showing the constitution of a consultation service terminal;

FIG. 3 is a view showing the constitution of a consultation service support terminal;

FIG. 4 is a view showing examples of the functions of each server;

FIG. 5 is a view showing examples of the programs stored in a shared server;

FIG. 6 is a view showing the constitution of the main parts of the terminal;

FIG. 7 is a view showing examples of the functions of the terminal;

FIG. 8 is a view showing examples of the programs stored in a terminal;

FIG. 9 is a flowchart showing an operation of the consultation service system;

FIG. 10 is a view showing an example of screen disposal;

FIG. 11 is a view showing an example of a virtual screen;

FIG. 12 is a view showing an example of an initial screen on a customer display unit;

FIG. 13 is a view showing an example of an initial screen on a counselor display unit;

FIG. 14 is a view showing an example of a channel screen;

FIG. 15 is a view showing an example of a screen on the counselor display unit;

FIG. 16 is a view showing an example of a screen on the counselor display unit;

FIG. 17 is a view showing an example of a screen on the counselor display unit;

FIG. 18 is a view showing an example of an initial screen on the consultation service support terminal;

FIG. 19 is a view showing an example of a screen on the consultation service support terminal;

FIG. 20 is a view showing an example of a screen on the customer display unit;

FIG. 21 is a view showing an example of a screen on the counselor display unit;

FIG. 22 is a view showing an example of a screen on the counselor display unit;

FIG. 23 is a view showing the operations of each server;

FIG. 24 is a view showing the operations of each server; and

FIG. 25 is a view showing the operations of each server.

### DESCRIPTION OF THE PREFERRED EMBODIMENTS

An embodiment of the present invention will be described below with reference to the drawings. Note that in each drawing, the form, magnitude, and positional relationships of each constitutional component are merely illustrated schematically in order to facilitate understanding of the present invention. Further, common elements in each drawing have been allocated identical reference symbols, and duplicate description thereof has been omitted. Note that in the following description, the service provider is a bank. Further, the operator of the consultation service terminal will be referred to as a counselor or staff member, and the operator of the consultation service support terminal will be referred to as a supporter or operator.

[System Constitution]

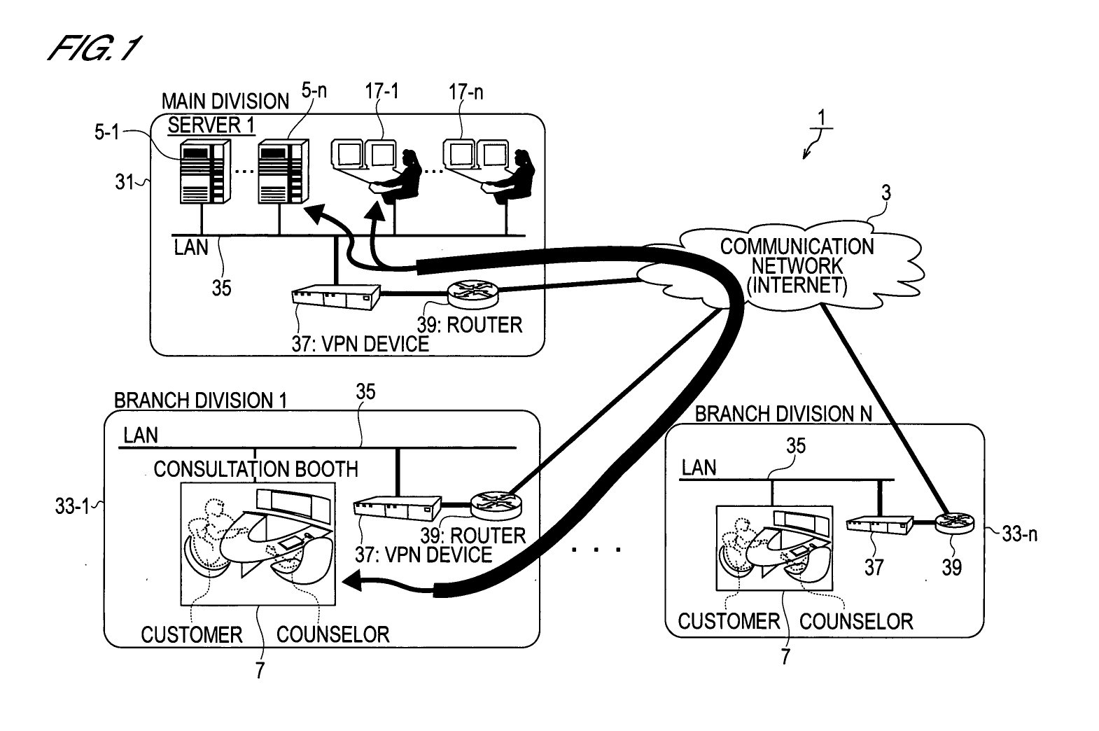

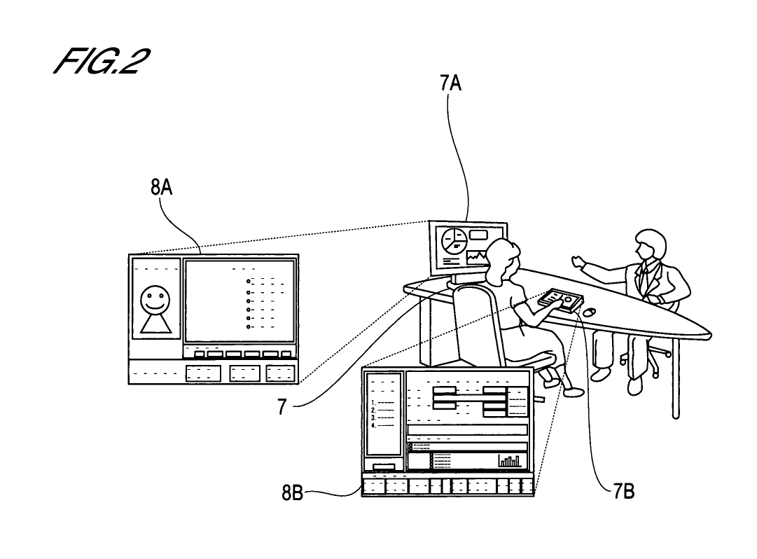

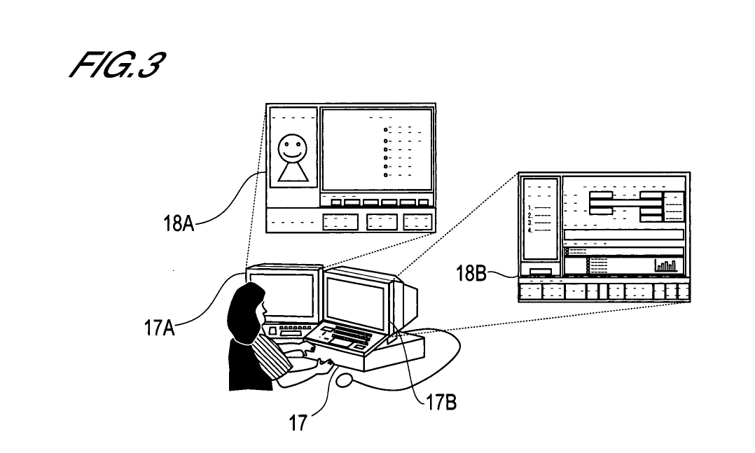

FIG. 1 is a view showing the constitution of a consultation service system according to the present invention, FIG. 2 is a view showing the constitution of a consultation service terminal, and FIG. 3 is a view showing the constitution of a consultation service support terminal.

As shown in FIG. 1, a consultation service system 1 is constituted by a server 5, a consultation service terminal 7, a consultation service support terminal 17, and so on, connected via a communication network 3. Note that the consultation service terminal 7 and consultation service support terminal 17 will be referred to together as “the terminals” below.

The structural equipment of the consultation service system 1 is normally divided between a main division 31 and branch divisions 33-1 to 33-n. The structural equipment on the main division 31 side comprises servers 5-1 to 5-n, consultation service support terminals 17-1 to 17-n, and so on, for example. The structural equipment on the side of the branch divisions 33-1 to 33-n comprises the consultation service terminal 7 and other terminals not shown in the drawing, for example. Note that in the example shown in FIG. 1, only one main division 31 is provided, but a plurality may be provided. Also in the example shown in FIG. 1, only one consultation service terminal 7 is provided for each of the branch divisions 33-1 to 33-n, but in reality, a desired number of consultation service terminals 7 would be disposed in each of the branch divisions 33-1 to 33-n.

The structural equipment of the main division 31 and the structural equipment of each of the branch divisions 33-1 to 33-n are connected through internetworking devices such as a virtual private network device (VPN device) 37 and a router 39, and through the communication network 3 such as the Internet. Note that the VPN device 37 is a connection device for protecting communication security. During communication, the VPN device 37 connects specific terminals after identifying the terminals, and thus prevents another terminal from interrupting the connection between the specified terminals. The router 39 is a connection device comprising a relay function for delivering IP packets to a destination host. In recent years, routers having a VPN function have come into existence, and hence the VPN device 37 and router 39 may be integrated.

In this consultation service system 1, the communication network 3 is a broadband network capable of communicating images. The communication network 3 may be a public network such as an Internet network or wireless communication network, but is preferably a private network such as a wide local area network (wide area LAN).

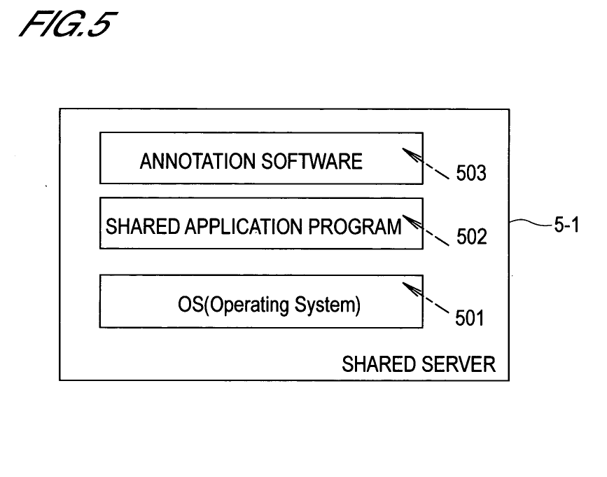

The servers 5-1 to 5-n comprise various functions to be described below, and execute various calculations. One or a plurality of the servers 5-1 to 5-n stores a shared application program (to be referred to as “shared application” below) 502, such as that shown in FIG. 5 to be described below, which can be operated by both of the terminals (consultation service terminal 7, consultation service support terminal 17), and the shared application 502 is executed on the basis of an operation of the terminals. Hence the shared application 502 is executed not by the terminal, but by a server (any one of the servers 5-1 to 5-n), and the terminal simply serves to display an image indicating the result of an execution of the shared application 502 performed by the server. Note that the server which stores and executes the shared application 502 will be referred to below as the “shared server”. In the following description, the server 5-1 will be described as the shared server.

The consultation service terminal 7 is a device for implementing a consultation service with a customer, and is capable of operating the shared application 502 stored in the shared server 5-1.

The consultation service terminal 7 is constituted by a computer installed with a program for realizing a consultation service terminal function. The computer which constitutes the consultation service terminal 7 comprises a TV camera, microphone, and speakers, for example, not shown in the drawings, and is thus capable of executing a TV conference. As shown in FIG. 2, the consultation service terminal 7 is constituted such that a customer and counselor face each other on opposite sides of a table, and is provided with a display unit for displaying appropriate images for the consultation subject of the customer (to be referred to as “customer display unit” below) 7A, and a display unit for displaying images for use by the counselor (to be referred to as “counselor display unit” below) 7B. The customer display unit 7A is disposed to be viewable from the customer side and counselor side, whereas the counselor display unit 7B is disposed to be viewable from the counselor side but not from the customer side. Further, the counselor display unit 7B shown in FIG. 2 is a touch panel combining a display function and an input function, but the input function may be provided as a separate device (for example a keyboard, pen input device, or similar).

The consultation service support terminal 17 is a device for supporting a consultation service, and is capable of operating the shared application 502 stored in the shared server 5-1. The consultation service support terminal 17 is constituted by a computer installed with a program for realizing a consultation service support terminal function. Note that since the consultation service terminal 7 is provided with two display units, the consultation service support terminal 17 is also preferably provided with two display units to be able to correspond thereto. For example, the consultation service support terminal 17 shown in FIG. 3 comprises a first display unit 17A corresponding to the customer display unit 7A of the consultation service terminal 7, and a second display unit 17B corresponding to the counselor display unit 7B of the consultation service terminal 7. The consultation service support terminal 17 displays on the first display unit 17A an identical image (or an image including a part of this image) 18A to an image 8A displayed on the customer display unit 7A, and displays on the second display unit 17B an identical image (or an image including a part of this image) 18B to an image 8B displayed on the counselor display unit 7B.

The consultation service system 1 is connected to external equipment (for example, a group of external computers, a group of computers of business associates, and so on). Hence the equipment of the consultation service system 1 can obtain various information from the external computer group, business associate computer group, and so on. In particular, when the consultation service system 1 is connected to a group of business associate computers, the group of business associate computers can serve as consultation service support terminals, and the business associates themselves can serve as supporters of the consultation service. Hence a consultation service with a high level of expertise can be provided. Note that the business associate may be an individual or an organization.

[Server Constitution]

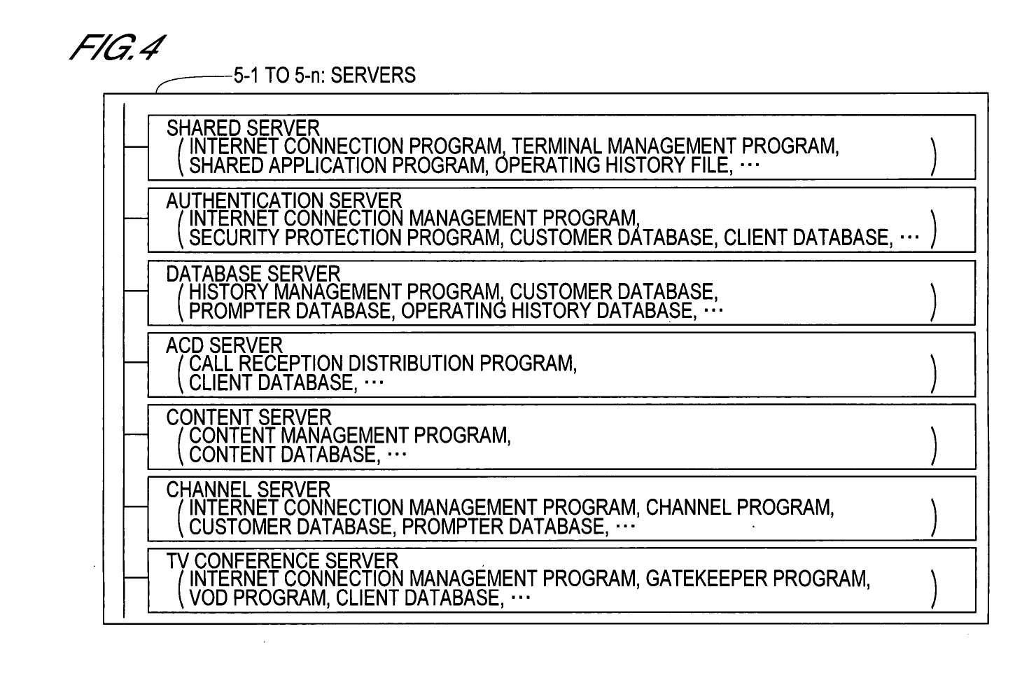

FIG. 4 is a view showing examples of the main functions of each server 5-1 to 5-n disposed in the main division 31, and FIG. 5 is a view showing examples of the programs stored in the shared server.

Each of the servers 5-1 to 5-n executes one or a plurality of the functions shown in FIG. 4. Note that a constitution in which one server executes all of the functions is possible, but in this case description will be provided assuming that each server 5-1 to 5-n executes one function.

A first main function is a shared server function. Functioning as the shared server signifies storing the shared application and executing the shared application on the basis of an operation from the terminals. In order to realize such a function, the shared server stores an Internet connection program, a terminal management program, the shared application, an operating history file, and soon, for example, as shown in FIG. 4. Here, the Internet connection program is a program for executing communication with the outside via the Internet. The terminal management program is a program for managing operating control rights to be described below and the terminals which possess these rights. The shared application is an application that can be operated by both the consultation service terminal 7 and the consultation service support terminal 17, and which creates a virtual screen to be described below on the basis of an operation from the consultation service terminal 7 or consultation service support terminal 17. The operating history file is a file for recording the history of operations from the consultation service terminal 7 or consultation service support terminal 17 during the implementation of consultation services.

The shared server is capable of controlling input by the counselor and supporter and controlling image display. During the control of input from the counselor and supporter in particular, the shared server enables data transmission and reception and image display in a chat format (a format enabling alphanumerical communication between people in remote locations). During image display control, commentary can be displayed, customer images 8A, 18A can be displayed on a customer display unit 7A of the consultation service terminal 7 or a first display unit 17A of the consultation service support terminal 17, and counselor images 8B, 18B can be displayed on a counselor display unit 7B of the consultation service terminal 7 or a second display unit 17B of the consultation service support terminal 17. Further, any image or information can be obtained from a contents server, and the customer images 8A, 18A or counselor images 8B, 18B can be displayed in accordance with the sequence of an explanation. The shared server is also capable of causing a printer not shown in the drawing but provided in the consultation service terminal 7 to perform printing in response to a printing instruction according to an operation of the consultation service support terminal 17.

A second main function is an authentication server function. Functioning as the authentication server entails specifying a terminal, person, or the like through which communication is to be performed, and authenticating the terminal or person. In order to realize this function, the authentication server stores an Internet connection management program, a security protection program, a customer database (to be referred to as “customer DB” below), a client database (to be referred to as “client DB” below), and so on, for example, as shown in FIG. 4. Here, the Internet connection management program is a program for managing connections between equipment and preventing infection of the system by a virus during communication between the equipment in the system via the Internet. The security protection program is a program for managing the authority of operators and terminals to access data having a set security level. The customer database (to be referred to as “customer DB” below) is a database for recording and managing data relating to customers. The client database (to be referred to as “client DB” below) is a database of recording and managing data relating to the operator of each terminal.

A third main function is a database server (to be referred to as “DB server” below) function. Functioning as the DB server entails storing and managing data relating to customers, prompter data to be described below for specifying images to be displayed on the display units, terminal operating histories, and so on. In order to realize such a function, the DB server stores a history management program, the aforementioned customer DB, a prompter database, an operating history database (to be referred to as “operating history DB” below), and so on, for example, as shown in FIG. 4. Here, the history management program is a program for creating a virtual screen to be described below on the basis of the operating history recorded in the operating history DB. The prompter database is a database for recording and managing prompter data to be described below. The operating history DB is a database for recording an operating history outputted from the shared server.

A fourth main function is an automatic call distributor (to be referred to as “ACD” below) server function. Functioning as the ACD server means appropriately allocating a call-making side terminal to a call-receiving terminal during communication between terminals, and thereby controlling/managing inter-terminal connections. In order to realize this function, the ACD server stores a call reception distribution program, the aforementioned client DB, and so on, for example, as shown in FIG. 4. Here, the call reception distribution program is a program for allocating a call-making side terminal to a call-receiving side terminal. Note that the allocated call-making side terminal and call-receiving side terminal are connected after being identified by the VPN device 37. The ACD server holds communication control rights even after the call-making side terminal and call-receiving side terminal have been connected, and hence controls the communication between the call-making side terminal and call-receiving side terminal. However, control rights may be transferred to the VPN device 37 after the call-making side terminal and call-receiving side terminal are connected such that communication control between the call-making side terminal and call-receiving side terminal is performed by the VPN device 37. In this case, communication between the call-making side terminal and call-receiving side terminal is performed without passing through the ACD server, and hence communication can be performed smoothly with little time-lag.

A fifth main function is a content server function. Functioning as the content server means storing various images created in accordance with the consultation service, and providing these images to a server when various applications are executed on the server. In order to realize this function, the content server stores a content management program, a content database (to be referred to as “content DB” below), and so on, for example, as shown in FIG. 4. Here, the content DB is a database for recording and managing images of various types of content, and the content management program is a program which, when predetermined content has been read out from the shared server, DB server, or the like, outputs images of corresponding content from the content DB to the shared server, DB server, or the like.

A sixth main function is a channel server function. Functioning as the channel server means storing the results of a customer analysis performed by a computer (for example, customer credit worthiness, account balance, the type of service to be provided to the customer, and so on), data inputted by a counselor (for example, favor able or unfavorable impressions of the customer, messages from a previous counselor to a following counselor, and so on), and other data, and providing these data (to be referred to as “channel data” below) to a server when various applications are executed on the server. In order to realize this function, the channel server stores the aforementioned Internet connection management program, a channel program, the aforementioned customer DB and prompter DB, and so on, for example, as shown in FIG. 4. Here, the channel program is a program for creating images on a screen used for displaying channel data (to be referred to as “channel screen” below). Note that data which are preferably to be concealed from the customer in particular, such as the channel data presented here or data for assisting a consultation service with a customer that are outputted from the consultation service support terminal to the consultation service terminal in the chat format to be described below or by another method, will be referred to as “confidential data”.

A seventh main function is a TV conference server function. Functioning as the TV conference server entails executing a TV conference by transceiving between terminals images and audio obtained through a camera and microphone not shown in the drawings. In order to realize this function, the TV conference server stores the aforementioned Internet connection management program, a gatekeeper program, a video-on-demand program (to be referred to as “VOD program” below), the aforementioned client DB, and so on, for example, as shown in FIG. 4. Here, the gatekeeper program is a program for preventing another terminal from interrupting communication between terminals. The VOD program is a program for distributing moving images or still images recorded in advance in the TV conference server and DB server to a specific terminal.

Note that in the following description, the server 5-1, server 5-2, server 5-3, server 5-4, server 5-5, server 5-6, and server 5-7 refer to the shared server, authentication server, DB server, ACD server, content server, channel server, and TV conference server respectively.

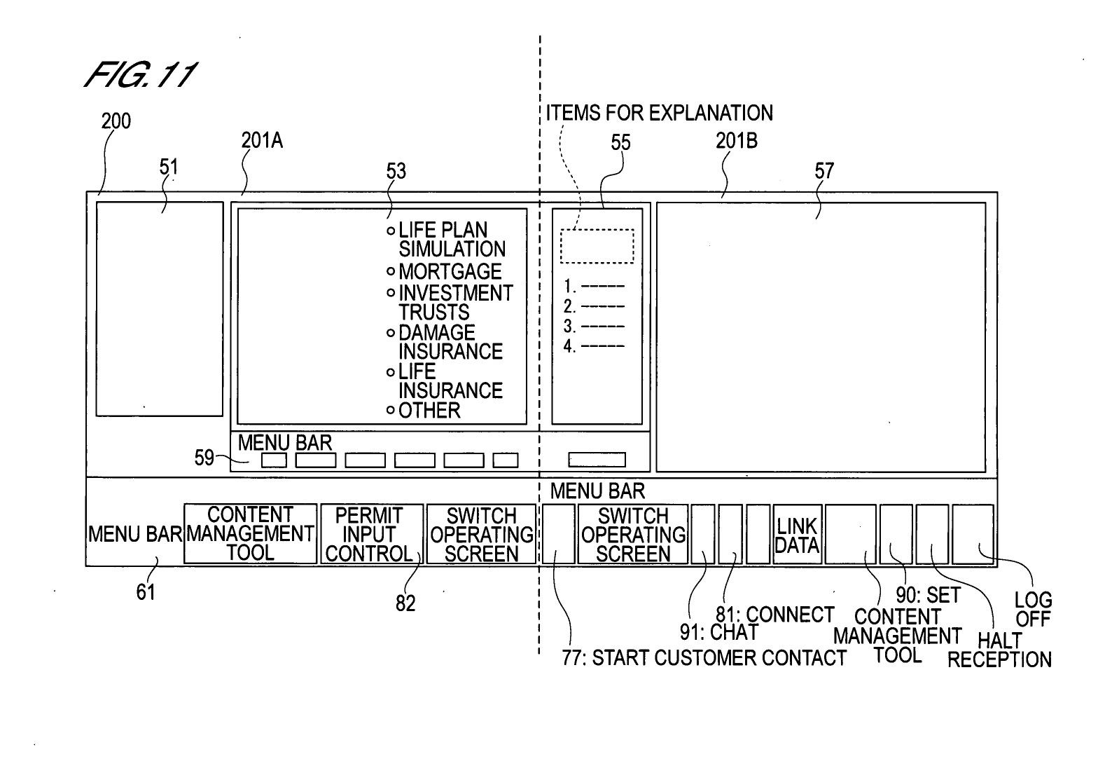

As shown in FIG. 5, the shared server 5-1 stores an operating system (to be referred to as “OS” below) 501, the shared application 502, annotation software 503 for depicting annotations such as circles, lines, and alphanumeric characters, and so on, for example. By executing the shared application 502, the shared server 5-1 creates a screen (a virtual screen 200 to be described below using FIG. 11) comprising an image which indicates the result of this execution, and outputs this screen to the consultation service terminal 7 and consultation service support terminal 17. Further, by executing the annotation software 503, the shared server 5-1 attaches annotations to the image on the virtual screen 200.

As a typical annotation-adding method, a window for inputting annotations is opened in the foreground of the virtual screen 200 and annotations are inputted therein. According to this method, however, the window is opened in the foreground of the virtual screen 200, and hence the majority of the virtual screen 200 is hidden behind the window. As a result, the images (including alphanumerical characters) hidden behind the window on the virtual screen 200 cannot be seen, and if the region into which data are to be inputted is also hidden behind the window, data cannot be inputted therein.

In order to prevent such problems from arising, it is preferable that instead of opening a window for inputting annotations, annotations such as circles, lines, alphanumerical characters, and so on be added directly to the image on the virtual screen 200. In this embodiment, the method of adding annotations will be described as one in which annotations are added directly to the image on the virtual screen 200 rather than opening a window for inputting annotations.

[Terminal Constitution]

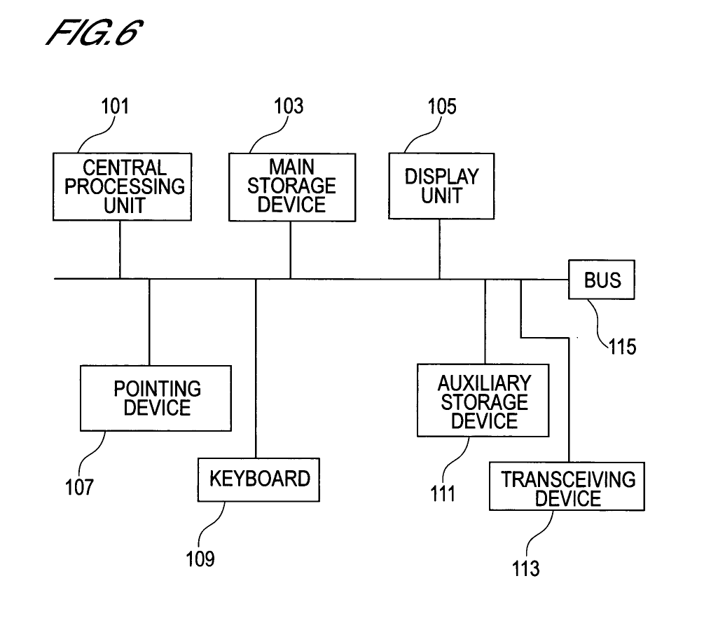

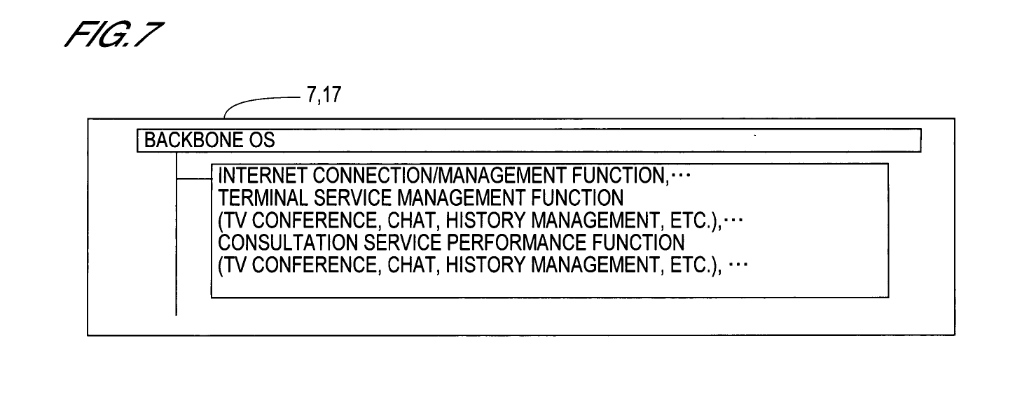

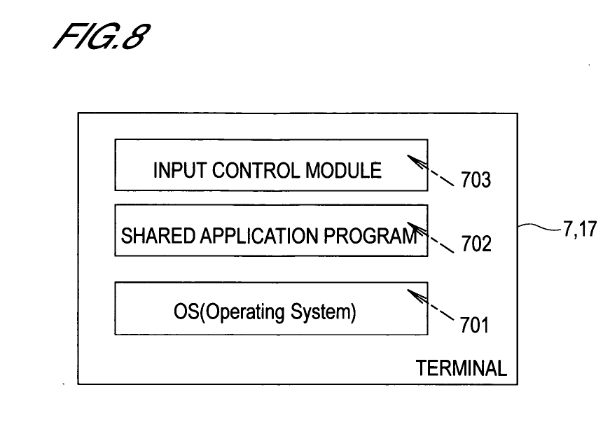

FIG. 6 is a view showing the constitution of the main parts of the terminals, FIG. 7 is a view showing examples of the functions of the terminals, and FIG. 8 is a view showing examples of programs stored in the terminals.

As shown in FIG. 6, the main parts of the terminals (the consultation service terminal 7 and consultation service support terminal 17) comprise a central processing unit (CPU) 101, a main storage device 103, a display unit 105, a pointing device 107, a keyboard 109, an auxiliary storage device 111, a transceiving device 113, and a bus 115. The central processing unit 101 controls each part via the bus 115, and displays various images on the display unit 105 (for example, a CRT, liquid crystal display, or similar) on the basis of input from the pointing device 107 (for example, a mouse or the like) and keyboard 109. The main storage device 103 is random access memory (RAM) or the like, and stores various data and programs. The auxiliary storage device 111 is a hard disk drive or the like, and stores various data and programs. The transceiving device 113 is a modem, LAN board, or similar.

As shown in FIG. 7, the terminals (for example, the consultation service terminal 7) comprise an Internet connection and management function, a terminal service management function, a consultation service performance function, and so on. The Internet connection and management function is a function for executing an operation of the shared application 502 or obtaining images and information of various content by making a connection with the shared server 5-1, the external computer group, the associate computer group, and so on. The terminal service management function is a function for making a connection with the consultation service support terminal 17 or another terminal and managing operating control rights to be described below in cooperation with the shared server in order to execute a TV conference, transmission and reception of alphanumeric data in a chat format, history management, and so on. The consultation service performance function is a function for displaying various screens suited to the consultation subject of the customer, and executing a TV conference, transmission and reception of alphanumeric data in a chat format, history management, and so on in order to perform a consultation service. The consultation service terminal 7 stores various programs and data for realizing these functions.

As shown in FIG. 8, the terminals (the consultation service terminal 7 and consultation service support terminal 17) store an OS 701, a shared application 702 for operating the shared application 502 which is stored in the shared server 5-1, an input control module 703 for managing control rights for operating the shared server 5-1, and so on, for example.

[System Operations]

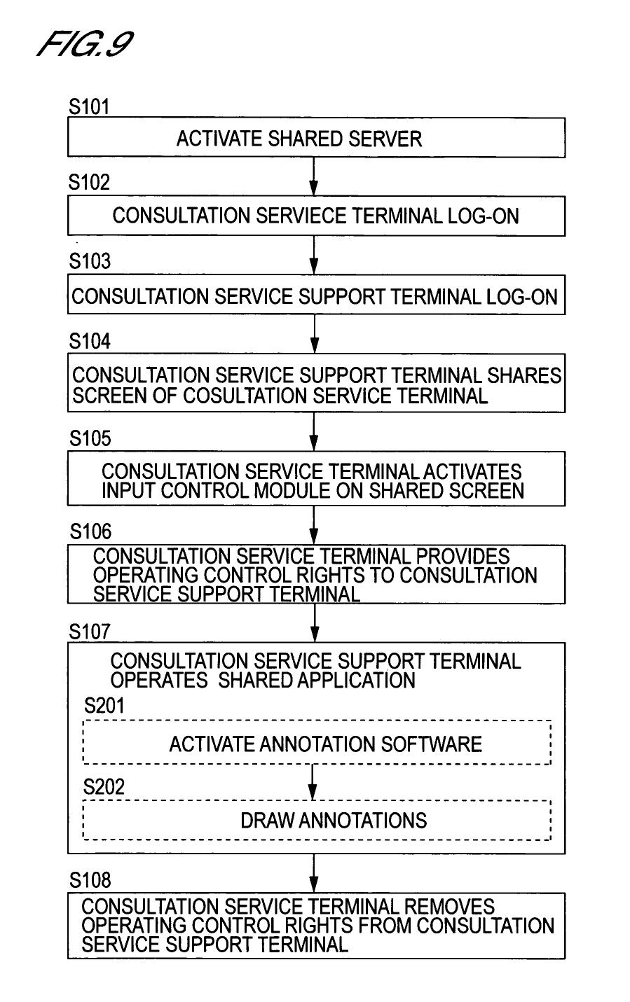

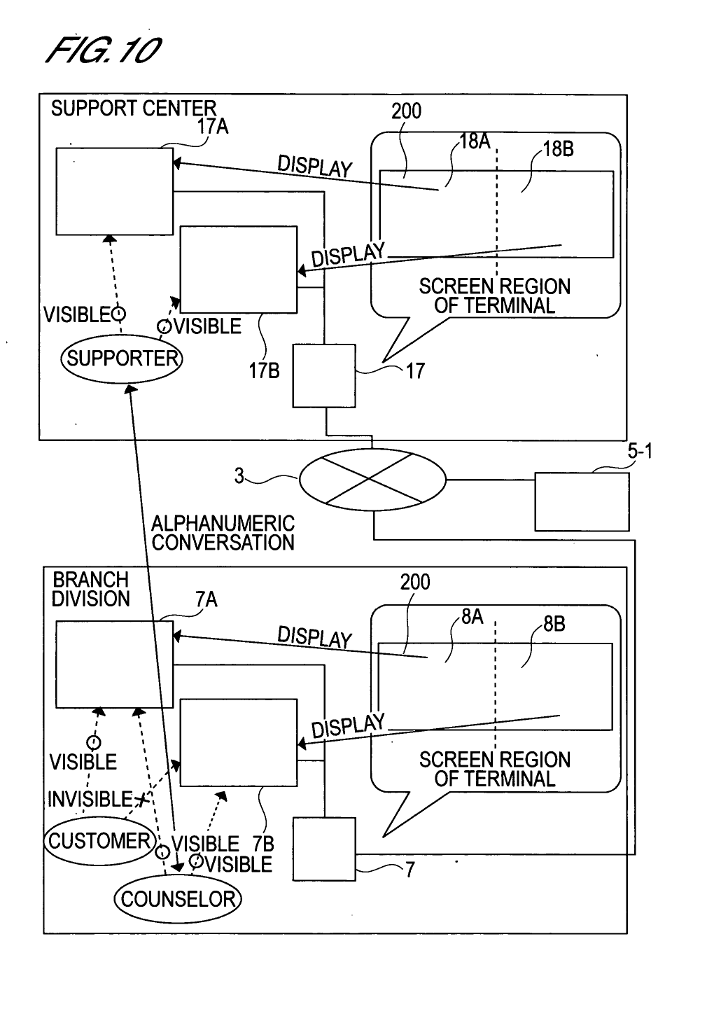

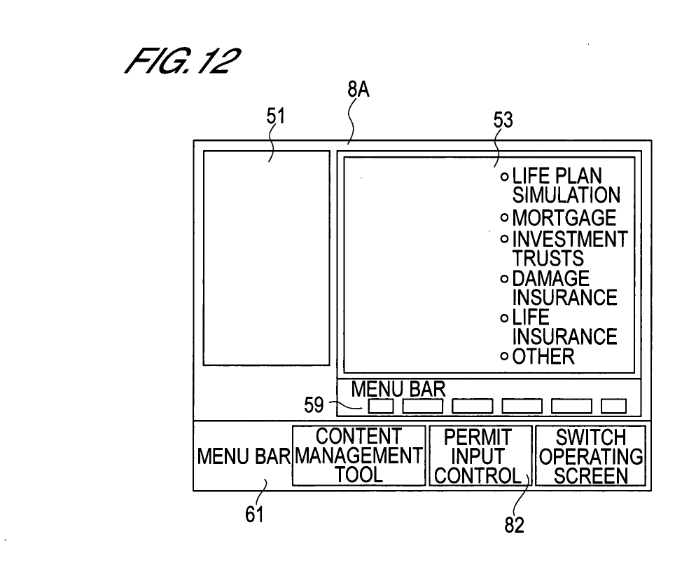

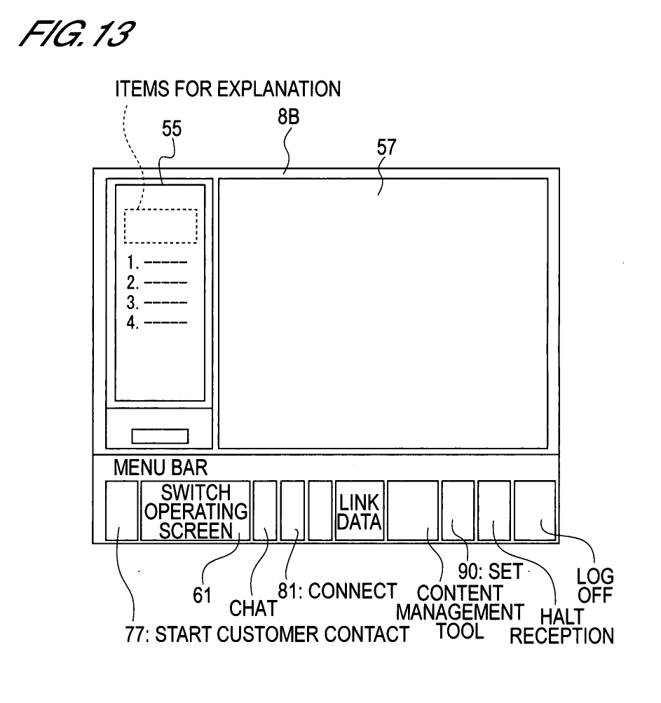

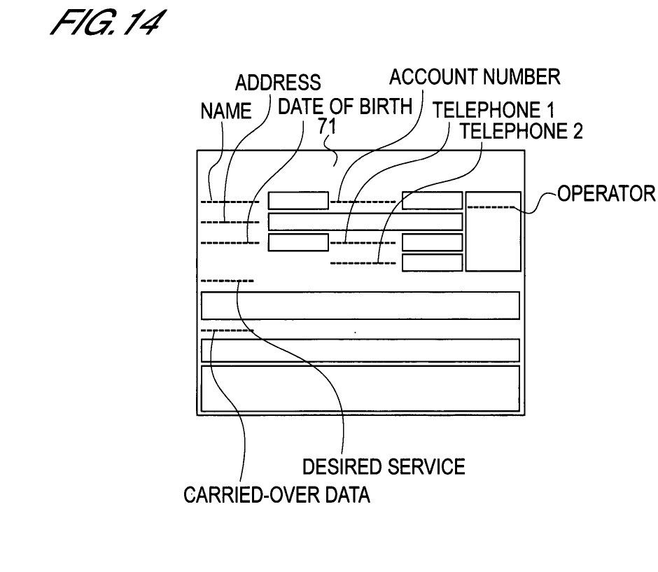

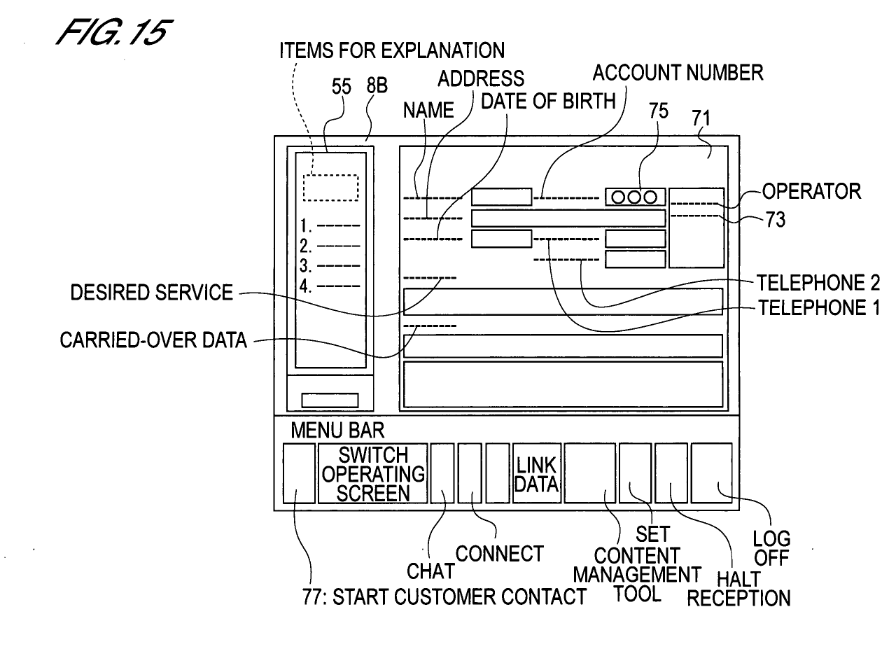

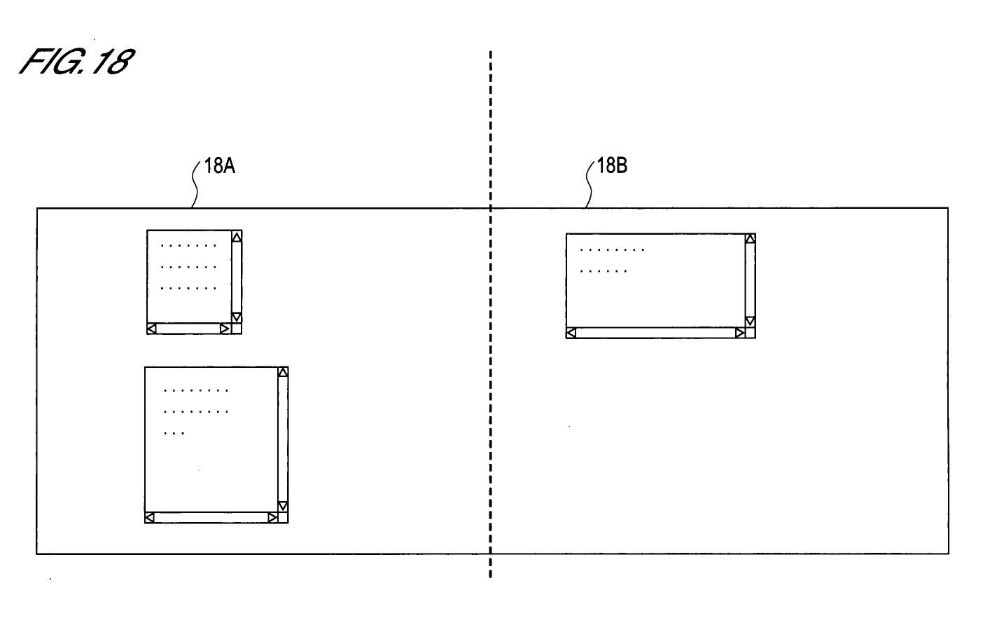

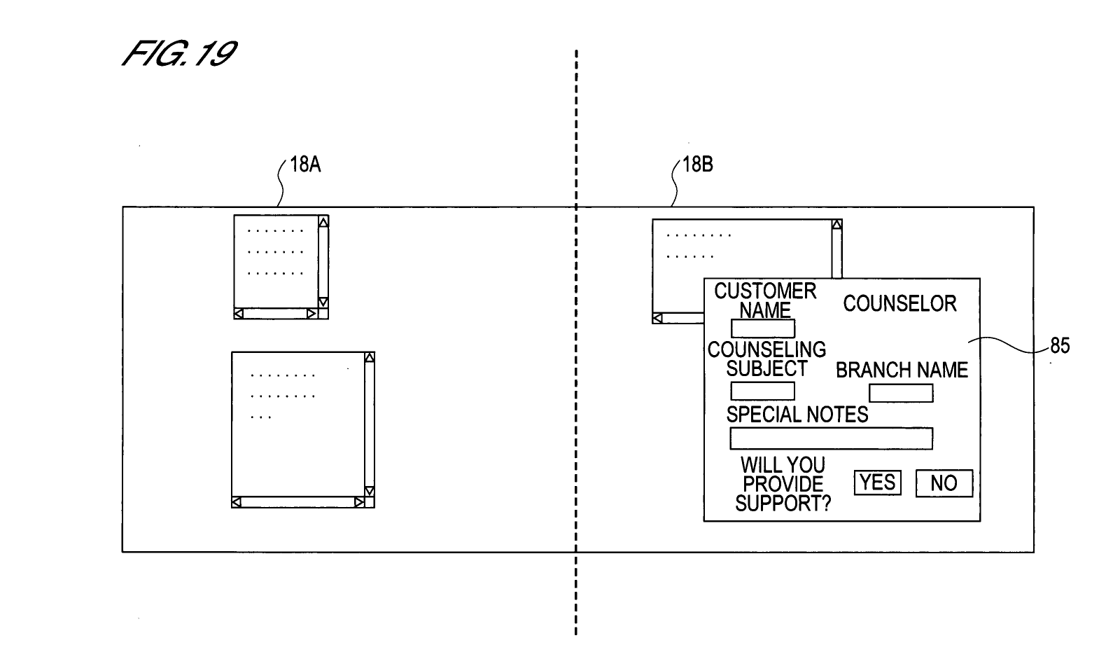

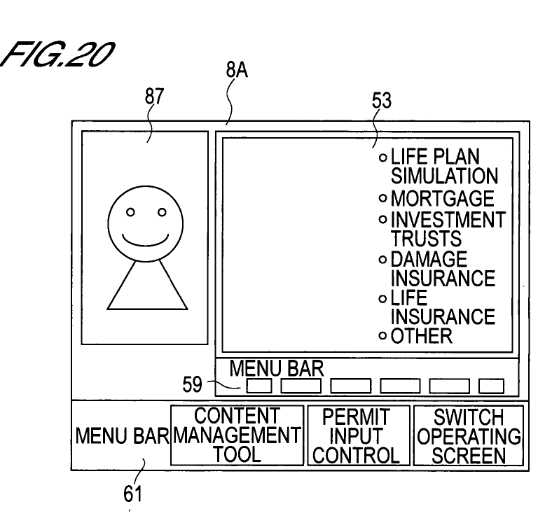

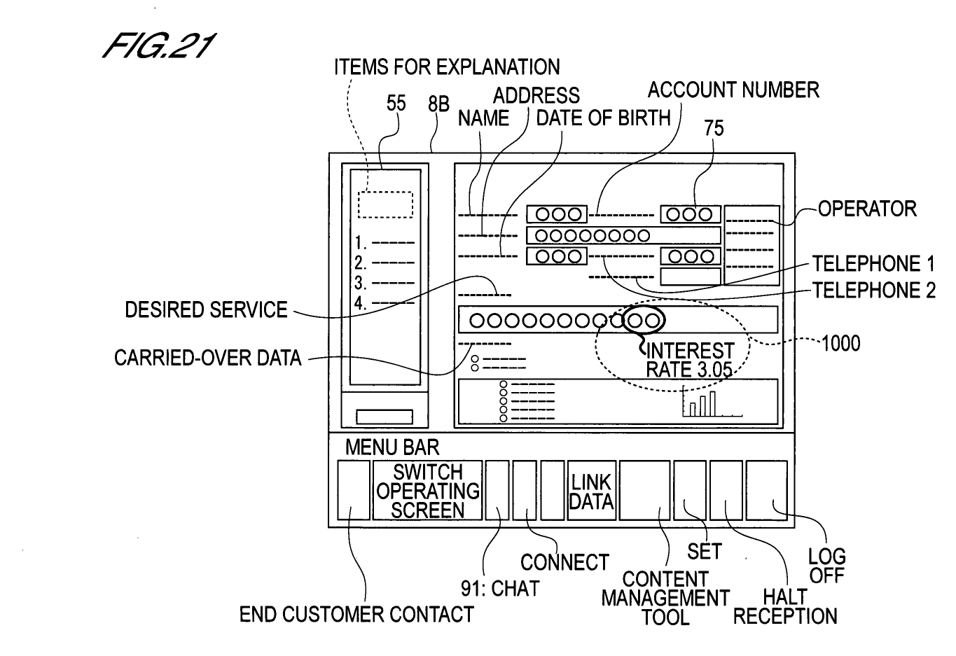

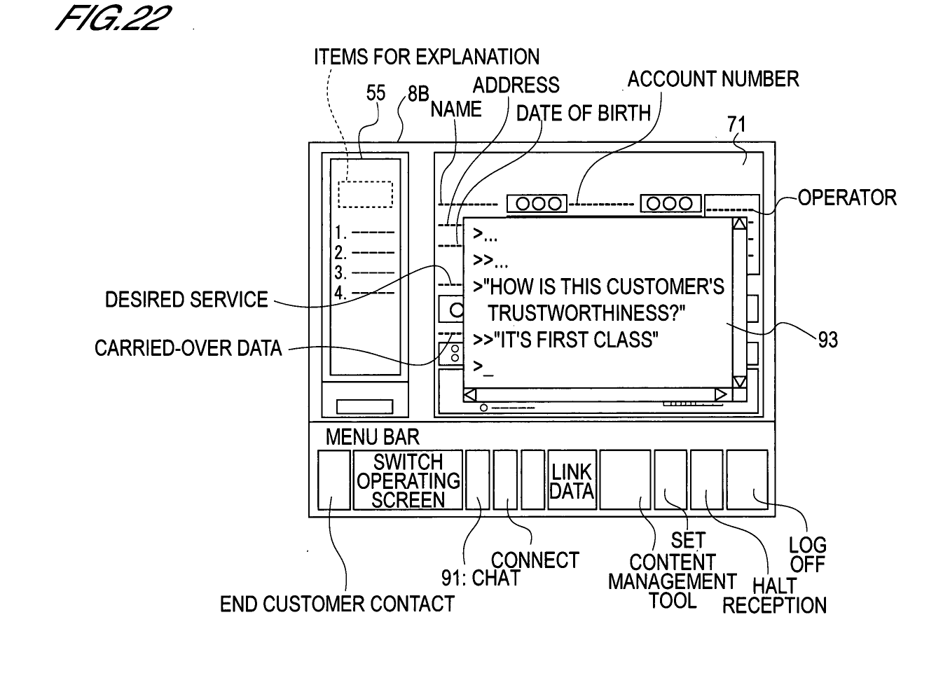

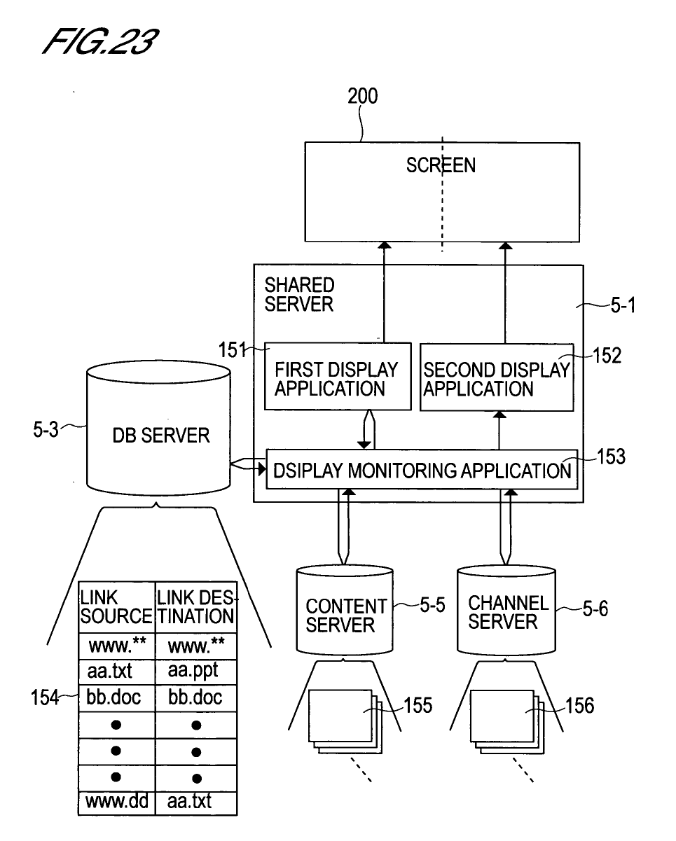

FIG. 9 is a flowchart showing an operation of the consultation service system. FIG. 10 is a view showing an example of screen disposal, FIG. 11 is a view showing an example of the virtual screen, FIG. 12 is a view showing an example of an initial screen on the customer display unit, FIG. 13 is a view showing an example of an initial screen on the counselor display unit, FIG. 14 is a view showing an example of a channel screen, FIGS. 15 to 17 are views showing examples of screens on the counselor display unit, FIG. 18 is a view showing an example of an initial screen on the consultation service support terminal, FIG. 19 is a view showing an example of a screen on the consultation service support terminal, FIG. 20 is a view showing an example of a screen on the customer display unit, FIGS. 21 and 22 are views showing examples of screens on the counselor display unit, and FIGS. 23 to 25 are views showing the operations of each server.

(Activation of the Consultation Service Terminal)

As shown in FIG. 9, first the shared server 5-1 is activated (step (to be referred to as “S” below) 101).

Next, at the beginning of the consultation service, the counselor presses a power switch of the consultation service terminal 7 not shown in the drawing. In so doing, the consultation service terminal 7 logs onto the system (S102) and begins connection with the shared server 5-1. At this time, the authentication server 5-2 identifies the consultation service terminal 7. When the consultation service terminal 7 is a correct pre-registered terminal, the authentication server 5-2 performs authentication and the result thereof is notified to the shared server 5-1. As a result, the shared server 5-1 permits a connection with the consultation service terminal 7 to be made. When the consultation service terminal 7 is an improper unregistered terminal, the authentication server 5-2 does not perform authentication, and the shared server 5-1 does not permit a connection to be made with the consultation service terminal 7. When the shared server 5-1 receives a connection from the consultation service terminal 7, the shared server 5-1 creates the image on the virtual screen 200 shown in FIG. 11, for example.

As shown in FIG. 11, the image on the virtual screen 200 comprises regions 51, 53, 55, 57, 59, 61, and so on, for example. The region 51 is a region in which a television conference image 87 to be described below is displayed during a television conference. The region 53 is a region in which images to be referred to by the customer and counselor (for example, a screen image corresponding to the assumed consultation subject of the customer (to be referred to as a “consultation subject screen” below), an image showing the results of an execution of the shared application 502, and so on) are displayed. The region 55 is a region in which explanation sequences, key points and so on required to perform the consultation are displayed. The region 57 is a region in which a screen image for displaying channel data created by the channel server 5-6 (to be referred to as a “channel screen” below) is displayed. The regions 59, 61 are both regions for displaying various menu bars used to operate the shared application 502 or another application. Note that selectable items or menu bars may also be provided in the regions 53, 55, 57. When a selectable item or menu bar is depressed, images or applications linked thereto are displayed or executed.

The image on the virtual screen 200 is created in the following manner.

As shown in FIG. 23, the shared server 5-1 stores a first display application 151 for displaying the consultation subject screen incorporated into a predetermined position on the virtual screen 200, a second display application 152 for displaying information for assisting the consultation service (to be referred to as “auxiliary information” below) incorporated into a predetermined position on the virtual screen 200, and a display monitoring application 153 which, when data comprised in the consultation subject screen are specified by the customer or counselor, displays auxiliary information linked to these data. Note that in the following description, the image displayed in the region 53 of the customer display unit 7A is an image of the consultation subject screen, whereas a channel screen image 71 displayed in the region 57 of the counselor display unit 7B is an image of the auxiliary information.

The image on the virtual screen 200, created by the shared server 5-1, is stored in the content server 5-5, for example, divided into an image 201A in a region on the left side of the broken line in FIG. 11 and an image 201B in a region on the right side of the broken line. The shared server 5-1 stores prompter data for specifying a combination of the image 8A displayed on the customer display unit 7A and the image 8B displayed on the counselor display unit 7B. The images specified by the prompter data are retrieved from the content server 5-5 and synthesized. Thus the image on the virtual screen 200 shown in FIG. 11 is created. The constitution of the prompter data is as follows, for example: <process number, URL of background part image of image 201A, URL of background part image of image 201B, URL of image incorporated into region 53, URL of image incorporated into region 55, . . . >. The shared server 5-1 retrieves the image 201A from the content server 5-5 on the basis of the URL of the image 8A displayed on the customer display unit 7A from the prompter data, retrieves the image 201B from the content server 5-5 on the basis of the URL of the screen displayed on the counselor display unit 7B from the prompter data, and synthesizes these images. Note that the constitution of the prompter data may be subjected to various modifications other than the constitution described above. For example, the following constitution is possible: <process number, title of background part image of image 201A, title of background part image of image 201B, title of image incorporated into region 53, title of image incorporated into region 55, . . . >.

A plurality of selectable items is displayed in the region 53 of the virtual screen 200. Here, the image displayed in the region 53 is a consultation subject screen, and the selectable items are the data comprised in the consultation subject screen. The customer or counselor specifies a certain selectable item. The DB server 5-3 stores a prompter data table (to be referred to as a “link data table” below) 154 for linking selectable items and auxiliary information (in this case, the image 71 displayed in the region 57). As shown in FIG. 23, for example, the link data table 154 is constituted as <link source address, link destination address>, for example. The display monitoring application 153 of the shared server 5-1 obtains data for the selectable items in the region 53 which are displayed by the first display application 151, and when a certain selectable item is specified, the display monitoring application 153 refers to the link datatable 154 of the DB server 5-3 to obtain the link destination address. The link destination address is then notified to the second display application 152. The second display application 152 obtains an image specified by the link destination address (that is, the image 71 serving as auxiliary information) from the channel server 5-6, and incorporates this image into the region 57 of the virtual screen 200. Note that the constitution of the link data table 154 maybe subjected to various modifications other than the constitution described above. Thus in this embodiment, auxiliary information corresponding to the consultation subject can be displayed appropriately by a simple operation, thereby eliminating the need to search for the auxiliary information such that the customer is not kept waiting and the length of the consultation service can be reduced. Also in this embodiment, all of the information is not displayed on a single application screen, but instead is divided between separate application screens such that auxiliary information can be displayed therein. At this time, the images on the entire screen are not created by a single application, but instead are related to exclusive display applications for each of the several regions (for example, the regions 51, 53, 55, 57) existing within the screen, and thus each exclusive display application creates the image in the related region. The images created in this manner are displayed such that only the data to be studied by the customer are gathered together within a single application screen, thereby reducing the amount of time required for the customer to study the data. Further, since the exclusive display applications related to each region create the images in each region, the constitution of the shared application 502 can be simplified and processing speed can be improved.

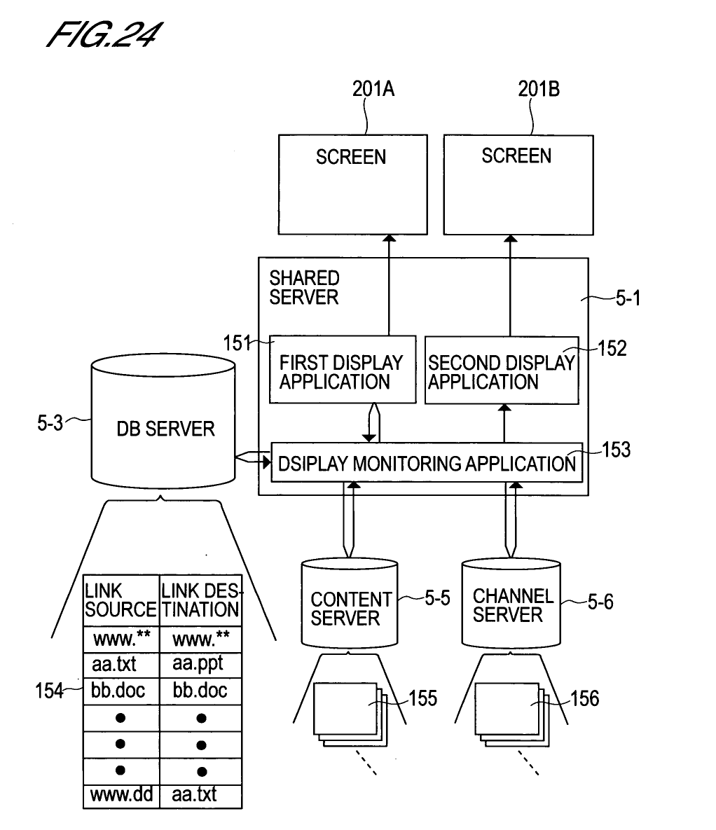

The first display application 151 and second display application 152 shown in FIG. 23 may be modified as shown in FIG. 24. That is, the first display application 151 and second display application 152 may operate so as to limit the regions for displaying images, whereby the first display application 151 performs display control of the image 201A which does not include confidential data, and the second display application 152 performs display control of the image 201B which does include confidential data. Thus confidential data can be displayed on the counselor display unit 7B which can only be viewed by the counselor, thereby solving the problem of high costs for creating and distributing auxiliary information.

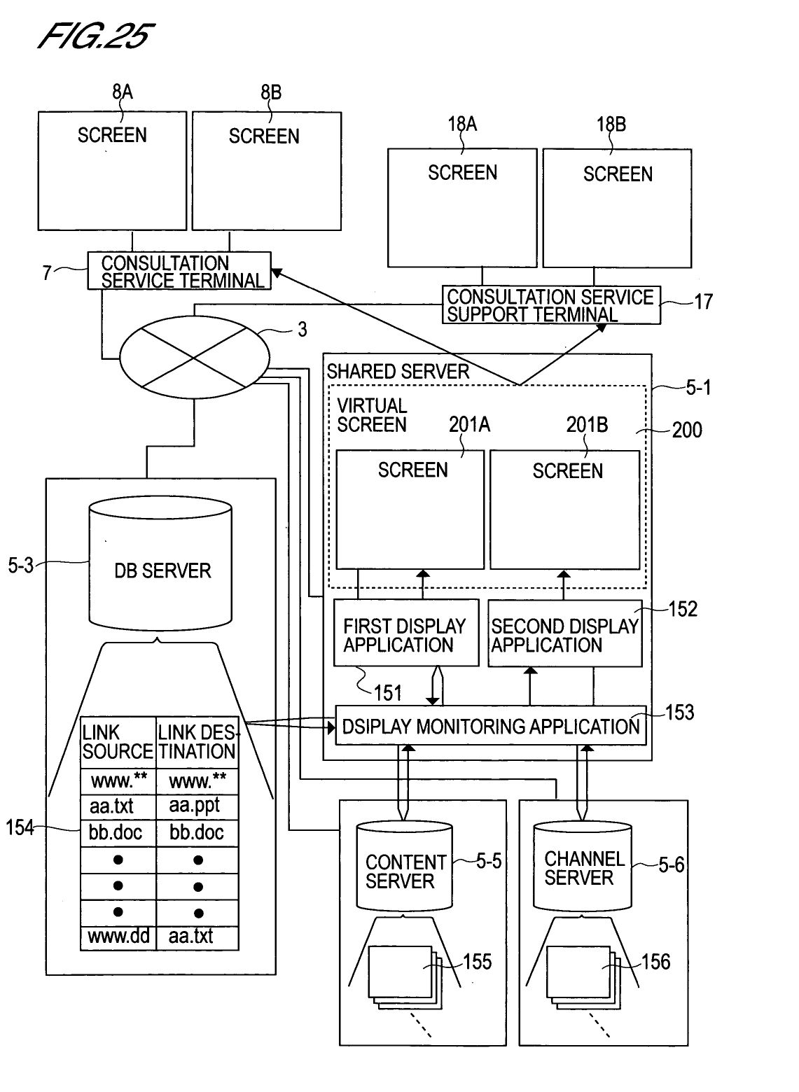

Further, as shown in FIG. 25, the shared server 5-1 is capable of outputting the image on the virtual screen 200 to the consultation service terminal 7 and consultation service support terminal 17. Hence the consultation service support terminal 17 is able to display the image currently displayed on the consultation service terminal 7. As a result, the procedure for displaying the same image by having a supporter in a remote location verbally confirm the image displayed on the consultation service terminal with the supporter can be eliminated, enabling a reduction in the amount of time required for a consultation service.

The consultation service terminal 7 obtains the image on the virtual screen 200 from the shared server 5-1. The image on the virtual screen 200 comprises a customer image (that is, an image to be viewed by the customer) and a counselor image (that is, an image to be viewed by the counselor and concealed from the customer). In the example shown in FIG. 11, the image 201A in the region on the left side of the broken line is the customer image, and the image 201B in the region on the right side of the broken line is the counselor image. The consultation service terminal 7 divides the image on the virtual screen 200 into the images 201A and 201B, whereby the image 201A is displayed on the customer display unit 7A as the customer image 8A shown in FIG. 10, and the image 201B is displayed on the counselor display unit 7B as the counselor image 8B shown in FIG. 10. As shown in FIG. 10, the customer display unit 7A is disposed to be viewable from the customer side and counselor side, whereas the counselor display unit 7B is disposed to viewable from the counselor side but not from the customer side. Thus the counselor is able to perform the consultation service while showing the customer appropriate data for the consultation subject of the customer and referring to confidential data. In FIG. 11, an arrow for specifying an input location is not displayed, but such an arrow is displayed in a predetermined position on an actual image. This arrow may be moved around the screens of the customer display unit 7A and counselor display unit 7B by an operation of the pointing device (for example, a mouse or the like) of the consultation service terminal 7, not shown in the drawing, performed by the counselor. When the counselor manipulates the arrow, various operations (for example, selecting a selectable item displayed on both of the screens, inputting data into a predetermined column displayed on both of the screens, altering the display position of an image displayed on both screens (for example, an image displayed in the regions 53, 55, 57, 59, 61, and so on) or the size of a region, and so on) can be performed.

Note that among the images displayed on the customer display unit 7A and counselor display unit 7B, the display position of some images is limited to either the customer display unit 7A or the counselor display unit 7B. For example, images comprising highly confidential data or the like must be concealed from the customer. Data for limiting the display position (to be referred to as “display position limiting data” below) are attached to such images. A judgment is made by a person in the main division 31 as to whether or not limitations should be placed on an image or data included in the image, for example, and if it is judged that limitations should be placed thereon, the display position limiting data are attached to the image or data and recorded in a server (for example, the shared server 5-1, DB server 5-3, content server 5-5, channel server 5-6, and so on). When an image or data to which the display position limiting data are attached is found, the shared server 5-1 limits the display position of the image or data included in the image such that the image or data cannot be moved to the customer display unit 7A, for example. Note that the system may be constituted such that limitations on the display position of an image and the removal thereof can be performed at will by an operation of the consultation service terminal 7. In this case, for example, the counselor can perform such a operation by specifying an image on which display position limitations are to be placed or removed using the pointing device not shown in the drawing, and then pressing a set bar 90 shown in FIGS. 11, 13 such that an operation to place or remove the display position limitations is executed.

The image on the virtual screen 200 may be created before the consultation service terminal 7 is connected to the shared server 5-1. The image on the virtual screen 200 may also be subjected to various modifications in accordance with applications, specifications, and so on.

(Beginning of Customer Contact)

Next, it is assumed that a customer visits the bank in order to discuss a loan application or the like. To begin a consultation with the customer, the counselor presses a customer contact start bar 77 shown in FIGS. 11 and 13. Note that the customer contact start bar 77 is a menu bar indicating the beginning of a consultation with a customer. At this time, the ACD server 5-4 (or the authentication server 5-2 or DB server 5-3) updates the data in the database for managing the consultation service terminal 7 from “unconnected” to “activated”, and then from “activated” to “in contact”. In so doing, the consultation service terminal 7 can be caused to execute the shared application 502 stored in the shared server 5-1. The shared application 502 is executed by inputting data into various data input columns displayed within the image on the virtual screen 200 created by the shared server 5-1, by depressing the menu bars 59, 61 shown in FIG. 11, or by a similar method. Note that the shared application 502 is executed by the shared server 5-1 rather than the terminal, and that the terminal simply displays the image on the virtual screen 200 resulting from the execution of the shared application 502 performed by the shared server 5-1.

Now it is assumed that the consultation service with the customer begins. At this time, the consultation service terminal 7 displays the image shown in FIG. 12 and the image shown in FIG. 13 on the customer display unit 7A and counselor display unit 7B respectively. The counselor then depresses an item corresponding to the consultation subject of the customer from among the selectable items displayed in the region 53 of FIG. 12, for example. Then, the shared server 5-1 retrieves the image 71 shown in FIG. 14 from the channel server 5-6, and incorporates the image 71 into the region 57 of the virtual screen 200. Note that the image 71 is a screen image (channel screen) for displaying confidential data relating to the customer (to be referred to as “channel data” below). The image 71 may be modified in accordance with the consultation subject of the customer. The shared server 5-1 outputs the image on the virtual screen 200 with the image 71 incorporated into the region 57 to the consultation service terminal 7. As a result, the consultation service terminal 7 displays the image shown in FIG. 15, or in other words an image with the image 71 incorporated into the region 57, on the counselor display unit 7B.

Next, the counselor inputs a personal code into a region 73 for inputting an operator code, inputs data for specifying the customer, such as an account number, for example, and then presses the customer contact start bar 77. Note that the data for specifying the customer may comprise name, date of birth, telephone number, and so on, but preferably comprise an account number since an account number enables the customer to be specified as one person.

Next, the shared server 5-1 outputs the counselor code inputted into the region 73 to the authentication server 5-2. The authentication server 5-2 compares the counselor code inputted into the region 73 to data stored in a database, and outputs data indicating the operations that may be executed in accordance with the counselor code to the shared server 5-1. Thus, if the content of the operation performed by the counselor is included in the permitted operations, the shared server 5-1 performs calculations based on the operation, and if the content of the operation performed by the counselor is not included in the permitted operations, the shared server 5-1 halts the calculations based on the operation. It is assumed here that the content of the operation performed by the counselor is a permitted operation.

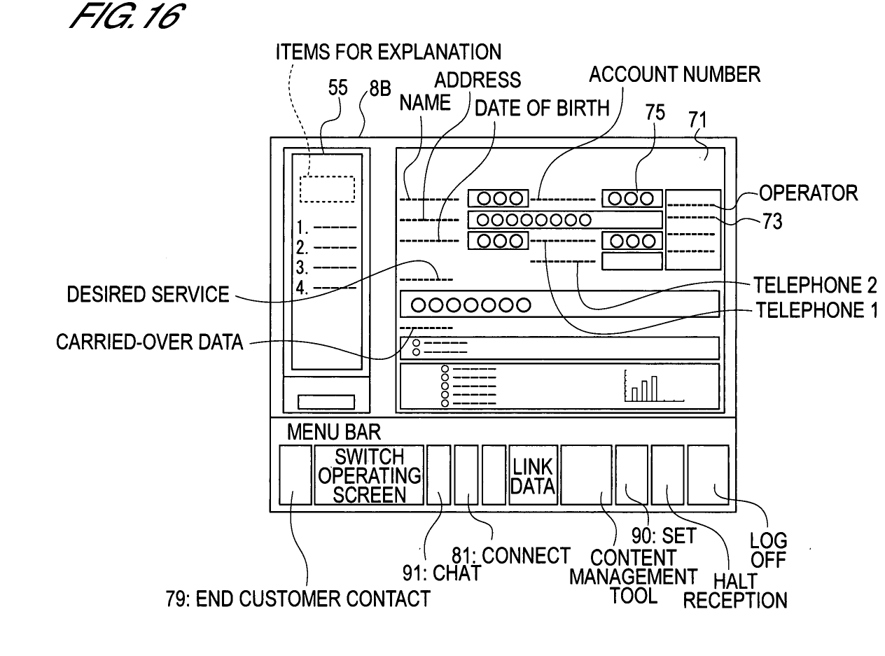

Next, the shared server 5-1 retrieves customer channel data from the channel server 5-6 on the basis of the data specifying the customer, and then creates the image shown in FIG. 16. The created image shown in FIG. 16 is then outputted to the consultation service terminal 7. Thus the consultation service terminal 7 displays the image shown in FIG. 16 on the counselor display unit 7B. The counselor conducts a consultation with the customer while viewing the image shown in FIG. 16. At this time, if there are any data to be recorded as channel data, the counselor inputs such data into a predetermined location on the image shown in FIG. 16. Note that in the image shown in FIG. 16, a customer contact end bar 79 for instructing the completion of the consultation with the customer is provided in place of the customer contact start bar 77.

Every time the shared server 5-1 executes the shared application 502 in accordance with an operation of the consultation service terminal 7 or consultation service support terminal 17 (for example, whenever the image on the virtual screen 200 is modified or the disposal position or content of the images in the regions 51, 53, 55, 57, 59, 61, and so on within the virtual screen is modified), an operating history is recorded. Recording of an operating history may be performed in accordance with the aforementioned prompter data format, for example. It is assumed, for example, that the counselor has modified the customer channel data. In this case, the shared server 5-1 outputs the image displayed in the region 57 of the counselor display unit 7B (in other words, the screen images displaying channel data shown in FIGS. 14 to 17 (to be referred to as the “channel image” below) 71) to the channel server 5-6. The channel server 5-6 stores the channel image 71 obtained from the shared server 5-1, and outputs data (for example, a URL, address, image title, or the like) specifying the region in which the channel image 71 has been stored to the shared server 5-1. Note that below, the data specifying the region in which the channel image 71 has been stored will be referred to as channel image storage data. The shared server 5-1 then stores this in the following format, for example: <process number, URL of background part image of image 201A, URL of background part image of image 201B, URL of image incorporated into region 53, URL of image incorporated into region 55, display region of channel image 71, channel server ID, channel image storage data, . . . >. Thus the shared server 5-1 records the operating history of the consultation service terminal 7 and consultation service support terminal 17. Note that when the consultation with the customer ends, the operating history is outputted to the DB server 5-3 and recorded by the DB server 5-3.

(Activation of Consultation Service Support Terminal)

Next, it is assumed that the consultation service support terminal 17 is activated. At this time, the supporter presses a power switch of the consultation service support terminal 17 not shown in the drawing. As a result, the consultation service support terminal 17 is logged onto the system (S103). At this time, the consultation service support terminal 17 is not yet connected to the consultation service terminal 7, and is on standby. The ACD server 5-4 (or the authentication server 5-2 or DB server 5-3) then updates the data in the database for managing the consultation service support terminal 17 from “unconnected” to “on standby”. Note that the consultation service system 1 is preferably constituted such that during a consultation with a customer, the consultation service support terminal 17 and consultation service terminal 7 cannot be connected from the consultation service support terminal 17 side. In so doing, a third party can be prevented from interrupting a consultation with a customer against the wishes of the counselor, and thus the counselor can focus exclusively on conversing with the customer. Malfunctions in the shared server 5-1, consultation service terminal 7, and peripheral equipment thereof can also be prevented. Further, since no unnecessary connections are made, increases in communication traffic can be prevented, whereby the system can be maintained in a favorable communication condition, and a situation in which no consultation service support terminals 17 are available for connection when a request for support is placed can be prevented.

(Request for Support)

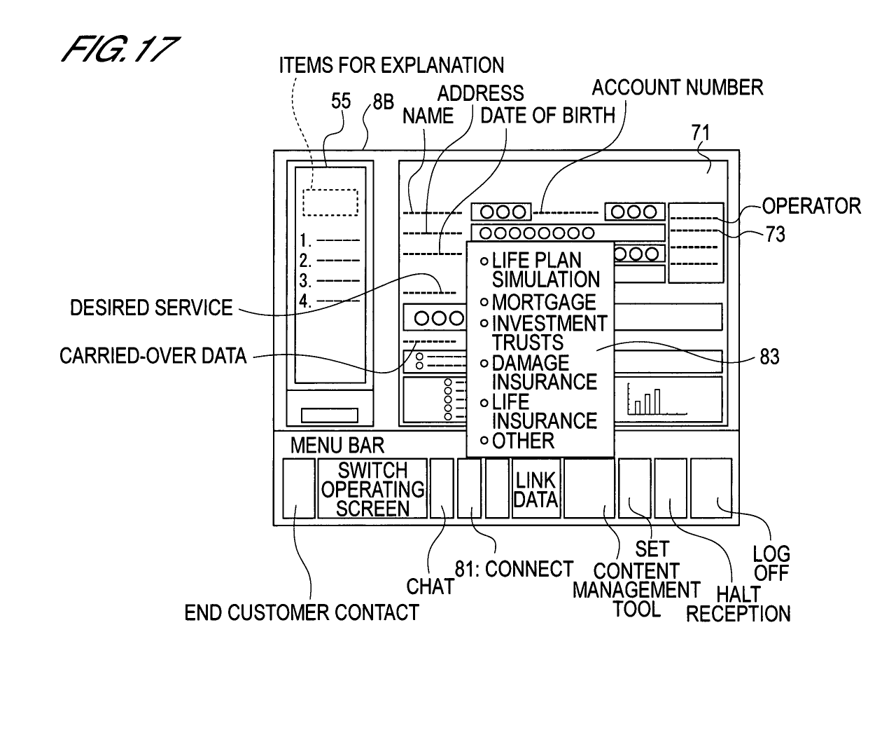

Next, it is assumed that during the consultation with the customer, a situation arises in which support is requested of a supporter. At this time, the counselor presses a connection bar 81 shown in FIG. 16, for example, and then presses a corresponding consultation subject item from among the selectable items shown in FIG. 17, which are displayed in response to depression of the connection bar 81. Note that the connection bar 81 is a menu bar indicating connection with the consultation service support terminal 17. On the basis of this operation, the shared server 5-1 outputs data indicating the support request source from which the connection bar 81 was pressed (for example, the ID of the consultation service terminal 7, the consultation subject classification, the name of the customer, the name of the counselor, and so on) to the ACD server 5-4. The ACD server 5-4 then selects a terminal from among the plurality of consultation service support terminals 17-1 to 17-n which can currently be connected, and which is being operated by a supporter who is capable of dealing most appropriately with the consultation subject. The VPN device 37 then connects the consultation service terminal 7 on which the connection bar 81 was pressed to the consultation service support terminal 17 selected by the ACD server 5-4.

At the time of initialization, the consultation service support terminal 17 displays the image shown in FIG. 18, for example. In FIG. 18, the image 18A in the region on the left side of the broken line is the image which is displayed on the first display unit 17A, and the image 18B in the region on the right side of the broken line is the image which is displayed on the second display unit 18B. FIG. 18 shows a state in which a window displaying a program has been opened on the background screen.

Having been selected by the ACD server 5-4, the consultation service support terminal 17 obtains the support request source data outputted from the ACD server 5-4. Then, as shown in FIG. 19, for example, the consultation service support terminal 17 displays an image 85 showing the support request source data on the first display unit 17A or second display unit 17B. Note that the support request source data comprise the consultation subject classification, the name of the customer, the name of the counselor, messages from a previous counselor to the following counselor, and so on, for example. The service provider may select one or a plurality of items therefrom and set these items as support request source data. Also, in this case the support request source data are outputted from the ACD server 5-4, but may be outputted from another server.

(Approval/Denial of Support)

The consultation service support terminal 17 is capable of approving or denying a request for support.

When a request for support is approved by the consultation service support terminal 17, for example, the supporter presses a key displayed as “YES” within the image 85, as a result of which a signal indicating support approval is outputted to the ACD server 5-4. Having received the signal indicating support approval, the ACD server 5-4 outputs data specifying the consultation service support terminal 17 which approved the support (the ID of the consultation service support terminal 17 or the like) to the shared server 5-1. The shared server 5-1 outputs an image indicating the results of the current execution of the shared application 502 (that is, the image on the virtual screen 200) to the consultation service support terminal 17 which approved the support. At this time, the shared server 5-1 outputs the image displayed on the customer display unit 7A of the consultation service terminal 7 to the consultation service support terminal 17 as an image to be displayed on the first display unit 17A, and outputs the image displayed on the counselor display unit 7B of the consultation service terminal 7 to the consultation service support terminal 17 as an image to be displayed on the second display unit 17B. Hence the consultation service support terminal 17 displays the same images as the images displayed on the consultation service terminal 7 at this time. Note that the consultation service support terminal 17 may be constituted to be capable of operations such as expanding or compressing the displayed image 18A or 18B. In this case, however, only the size of the image expanded into an image depiction memory, not shown in the drawing, in the interior of the consultation service support terminal 17 is altered, and the shared application 502 is not executed. Hence the image on the virtual screen 200 created by the shared server 5-1 does not change, and the image 8A or image 8B displayed on the consultation service terminal 7 does not change.

When a request for support is denied by the consultation service support terminal 17, the supporter presses a key displayed as “NO” within the image 85, as a result of which a signal indicating support denial is outputted to the ACD server 5-4. Having received the signal indicating support denial, the ACD server 5-4 repeats the process to search for a consultation service support terminal 17 which is capable of providing support until a consultation service support terminal 17 which approves the support is found.

Hence the consultation service support terminal 17 is capable of approving or denying a request for support from the consultation service terminal 7. When the support is approved, the consultation service support terminal 17 is capable of displaying an image indicating the results of an execution of the shared application 502 according to an operation of the consultation service terminal 7, and thus the supporter operating the consultation service support terminal 17 can grasp the content of the consultation with the customer, and can thereby provide support to the consultation service.

(Beginning of Support)

When the key displayed as “YES” on the image 85 is pressed by the supporter, the shared server 5-1 outputs the image currently displayed on the consultation service terminal 7 (in other words, the image on the virtual screen 200) to the selected consultation service support terminal 17. As a result, the consultation service support terminal 17 displays an identical image to the image currently displayed on the consultation service terminal 7 (S104) FIG. 20 is an example of the image displayed on the customer display unit 7A of the consultation service terminal 7 at this time. An example of the image displayed on the counselor display unit 7B of the consultation service terminal 7 at this time is shown in FIG. 16. Note that when a TV conference image 87 within FIG. 20 is displayed on the consultation service terminal 7, the image shows the face of the supporter, but when displayed on the consultation service support terminal 17, the image shows the face of the customer or counselor. The consultation service support terminal 17 in its initial state (that is, when an input control permission bar 82 has not been pressed) does not possess control rights for operating the shared application 502 of the shared server 5-1 (to be referred to as “operating control rights” below), and is only capable of displaying the image on the virtual screen 200 and severing the connection by pressing the connection bar 81. Note that the shared server 5-1 performs control such that operating control rights cannot be provided to the consultation service support terminal 17 by an operation on the consultation service support terminal 17 side.

Next, in order to provide operating control rights to the consultation service support terminal 17, the counselor presses the input control permission bar 82. On the basis of this operation, the shared server 5-1 activates the input activation module 703 (S105), whereby the consultation service terminal 7 provides operating control rights to the consultation service support terminal 17 (S106). As a result, the consultation service support terminal 17 becomes able to operate the shared application 502.

The supporter supports the consultation with the customer by operating the shared application 502 from the consultation service support terminal 17 (S107). At this time, support by the supporter is performed through the display of annotations, conversation in a chat format or television conference format, execution of an operation of the shared application 502 from the consultation service support terminal 17, and so on, for example.

Annotations are displayed by having the supporter activate the annotation software 503 stored in the shared server 5-1 using the consultation service support terminal 17 (S201), for example, and then adding annotations such as those shown in FIG. 21 to the image on the virtual screen 200 (S202). In the example in FIG. 21, the circle and the line leading therefrom depicted by bold lines and the alphanumerical characters “interest rate” and “3.05”, which are within a region 1000 surrounded by a broken-line ellipse, are annotations. As shown in FIG. 21, annotations are drawn directly onto the image on the virtual screen 200 using circles, lines, and alphanumerical characters such that the image on the virtual screen 200 is not hidden. The type of annotation (for example, a circle or ellipse, square or triangle, alphanumerical characters or predetermined patterns, and so on) can be selected in the following manner. For example, a window for selecting the type of annotation is preset in the application software 503, and hence by opening this window, a desired type of annotation is indicated using a pointing device such as a mouse. Annotations such as circles and ellipses, squares and triangles, predetermined patterns, and so on maybe drawn by manipulating the pointing device. Alphanumerical annotations may be depicted by determining the display position using the pointing device, and then inputting the desired characters using the keyboard.

This type of support by means of the display of annotations may be performed such that the conversation between the counselor and supporter is concealed from the customer, and is therefore suitable in cases where the content of the conversation is to be concealed from the customer. Since the counselor may view confidential data while studying the image on the virtual screen 200, this type of support is particularly suited to cases in which the counselor wishes to view confidential data while referring to the image on the virtual screen 200.

Support through conversation in a chat format is performed when the counselor depresses a chat bar 91 shown in FIG. 16, for example. At this time, the shared server 5-1 creates the image shown in FIG. 22 (that is, an image combining the image shown in FIG. 16 with a chat window 93), and outputs this image to the consultation service terminal 7 and consultation service support terminal 17. As a result, the consultation service terminal 7 displays the image shown in FIG. 22 on the counselor display unit 7B, and the consultation service support terminal 17 displays the image shown in FIG. 22 on the second display unit 17B. Hence the counselor and supporter may hold a conversation in a chat format. Support in a chat format may be performed such that the conversation between the counselor and supporter is concealed from the customer, and is therefore favorable in cases where the content of the conversation is to be concealed from the customer. Support through conversation in a chat format may also be performed using dictionary data prepared in advance. In this case, for example, the supporter operates the consultation service support terminal 17 such that dictionary data stored on a recording medium (such as a floppy (registered trademark) disk or CD-ROM, for example) or on the hard disk device of the consultation service support terminal 17 are expanded onto the second display unit 17B. The supporter then copies desired data from the expanded dictionary data and pastes the data onto the chat screen 93. In this manner, support using dictionary data prepared in advance is performed.

Support through conversation in a television conference format is performed when the counselor presses the input control permission bar 82, for example. At this time, the consultation service terminal 7 and consultation service support terminal 17 capture the image 87 using a camera not shown in the drawings. The obtained image 87 is then outputted from the consultation service terminal 7 to the consultation service support terminal 17 and from the consultation service support terminal 17 to the consultation service terminal 7 via the television conference server 5-7. Thereby, the consultation service terminal 7 and consultation service support terminal 17 can display the image shown in FIG. 20. The consultation service terminal 7 and consultation service support terminal 17 also obtain the voices of the customer or counselor and the supporter using a microphone not shown in the drawings and output the voices to each other. The consultation service terminal 7 and consultation service support terminal 17 output the voices obtained from each other through speakers not shown in the drawings. Thus the customer, counselor, and supporter can hold a conversation in a television conference format. Note that the consultation service terminal 7 and consultation service support terminal 17 may be constituted so as to output the image 87 to the shared server 5-1. In this case, the shared server 5-1 outputs to the consultation service terminal 7 an image in which the image 87 captured by the consultation service support terminal 17 is incorporated into the region 51 of the customer display unit 7A, and outputs to the consultation service support terminal 17 an image in which the image 87 captured by the consultation service terminal 7 is incorporated into the region 51 of the first display unit 17A.

Support through an execution of an operation of the shared application 502 from the consultation service support terminal 17 is performed when the counselor presses the input control permission bar 82 of the consultation service terminal 7, for example. The consultation service support terminal 17 in its initial state (that is, when the input control permission bar 82 is not depressed) does not posses operating control rights, but by pressing the input control permission bar 82, operating control rights are transferred to the consultation service support terminal 17. As a result, the consultation service support terminal 17 becomes capable of operating the shared application 502. Note that if the input control permission bar 82 displayed on the first display unit 17A is depressed when operating control rights have not been transferred to the consultation service support terminal 17, the rights will not be transferred to the consultation service support terminal 17.

Support through an execution of an operation of the shared application 502 from the consultation service support terminal 17 is performed when the supporter performs an operation on the shared application 502 from the consultation service support terminal 17, for example. In this case, the shared server 5-1 creates an image indicating the results of the execution of the shared application 502 in accordance with the operation on the consultation service support terminal 17, and outputs the created image to the consultation service terminal 7 and consultation service support terminal 17 such that an identical image is displayed on the consultation service terminal 7 and consultation service support terminal 17. This type of support also includes a case in which the supporter performs an operation from the consultation service support terminal 17 to cause printing to be executed. In this case, the shared server 5-1 drives a printer provided in the consultation service terminal 7 to execute printing.

Note that operating control rights are returned to the consultation service terminal 7 from the consultation service support terminal 17 when the counselor depresses the input control permission bar 82 displayed on the customer display unit 7A of the consultation service terminal 7 again, or when the supporter depresses the input control permission bar 82 displayed on the first display unit 17A of the consultation service support terminal 17 again.

(Interruption of Support)

Next, it is assumed that support is interrupted. At this time, the counselor presses the input control permission bar 82 on the consultation service terminal 7 again. On the basis of this operation, the shared server 5-1 causes the consultation service support terminal 17 to forfeit operating control rights (S108).

(End of Support)

Next, it is assumed that support is complete. At this time, the counselor presses the connection bar 81 on the image 8B shown in FIG. 17 again. As a result, the screens of the customer display unit 7A and counselor display unit 7B of the consultation service terminal 7 do not change, but the screens of the first display unit 17A and second display unit 17B of the consultation service support terminal 17 return to their initial images (for example, the image shown in FIG. 18).

(End of Customer Contact)

Next, it is assumed that the consultation with the customer is complete. At this time, the counselor presses the customer contact end bar 79 shown in FIG. 16. Note that the customer contact end bar 79 is a menu bar indicating the completion of contact with a customer. Operating control rights for ending a consultation are not provided to the consultation service support terminal 17. Hence even if the supporter presses the customer contact end bar 79 on the consultation service support terminal 17, the shared server 5-1 does not perform an operation to end the consultation.

When the customer contact end bar 79 on the consultation service terminal 7 is depressed, the shared server 5-1 closes the shared application 502 operated by the consultation service terminal 7. At this time, the screens of the customer display unit 7A and counselor display unit 7B of the consultation service terminal 7 return to their initial states (for example, the images shown in FIGS. 12 and 13). If the consultation service support terminal 17 is connected, the screens of the first display unit 17A and second display unit 17B of the consultation service support terminal 17 also return to their initial states (for example, the image shown in FIG. 18).

The shared server 5-1 then outputs the operating history recorded throughout the progression of the consultation with the customer (for example, recorded data in the aforementioned prompter data format) to the DB server 5-3, and the operating history is recorded in the DB server 5-3. As a result, the consultation service support terminal 17 is able to obtain a past history image (that is, an image indicating the result of an execution of the shared application 502 through an operation of the consultation service terminal 7 during a past consultation service with a customer) from the DB server 5-3 and display this image. Hence the supporter can view historical images from past consultation services with the customer. The consultation service terminal 7 and consultation service support terminal 17 may obtain past history images from the DB server 5-3 directly, or may obtain past history images from the DB server 5-3 via the shared server 5-1. In the latter case, the shared server 5-1 is caused to obtain a past history image from the DB server 5-3 and create an image on the virtual screen 200. This image on the virtual screen 200 is then obtained from the shared server 5-1.

Note that provision is preferably made such that if the counselor does not place a request for support, the image currently displayed on the consultation service terminal 7 cannot be displayed on another terminal (consultation service terminal 7, consultation service support terminal 17). In so doing, a third party can be prevented from interrupting a consultation between the customer and counselor during a consultation service with a customer against the wishes of the counselor. Since no third party selfishly interrupts the consultation service with the customer, malfunctions of the consultation service terminal 7 can be prevented. Further, since no unnecessary connections with other terminals are made, increases in communication traffic can be prevented, whereby the system can be maintained in a favorable communication condition. The fact that no unnecessary connections are made with other terminals also enables the prevention of a reduction in the number of available supporters when a request for support is placed. Further, since no third party interrupts the consultation with the customer, the counselor can concentrate exclusively on conversing with the customer.

According to the consultation service system 1 described above, when the counselor is unable to respond sufficiently to the consultation subject of the customer, the counselor may obtain data which correspond precisely to the consultation subject of the customer from the operator operating the consultation service support terminal 17. Hence even a counselor with little knowledge or experience can respond appropriately to the consultation subject of the customer. Further, operating control rights in the consultation service system 1 are controlled by the shared server 5-1, and thus the consultation service with the customer can be performed smoothly. Moreover, auxiliary information corresponding to the subject of the consultation can be appropriately displayed by a simple operation, and hence the need to search for the auxiliary information is eliminated, the customer is not kept waiting, and the amount of time required to complete a consultation service can be reduced.

The present invention is not limited to the embodiment described above, and various applications and modifications within a scope which does not deviate from the gist of the present invention may be considered.

For example, the consultation service system according to the present invention is not limited to a financial institution, and may be used in a consultation service with a customer in a transportation system, distribution facility, and so on.

Further, the consultation service terminal may be a window device in the form disclosed in Japanese Unexamined Patent Application Publication 2001-112595, which was disclosed in the prior art. The consultation service terminal may also be in the form of a contract-creating device having a consultation service function, an automatic teller machine (ATM), or a transaction device for selling tickets, distributing music, or performing another function.

Further, the consultation service terminal 7 may be constituted with more than two display units. In this case, the number of display units in the consultation service support terminal 17 is preferably aligned with the number of display units in the consultation service terminal 7.

Further, the plurality of screens on the display units of the consultation service support terminal 17 may be integrated into a single screen.

The consultation service terminal 7 may also be constituted so as to store the applications and data that are stored in the servers 5-1 to 5-n in the embodiment described above. By means of such a constitution, the consultation service terminal 7 may be operated when not connected to another device (that is, the servers 5-1 to 5-n, the consultation service support terminal 17, and soon), whereby, for example, after displaying the consultation subject screen, the link data table is used to retrieve from a database and display auxiliary information linked to the data comprised in the consultation subject screen.

The invention described above is effective in enabling the provision of a consultation service system which can display auxiliary information in a short amount of time and by a simple operation.

What is claimed is:

1. A consultation service system comprising a consultation service terminal for performing a consultation service with a customer, and a server which stores an application that can be operated by said consultation service terminal and executes said application on the basis of an operation performed on said consultation service terminal,
wherein said server uses a link data table for linking data comprised in a consultation subject screen which corresponds to the consultation subject of the customer with auxiliary information for assisting the consultation service in order to create a virtual screen comprising the consultation subject screen and auxiliary information, and outputs an image of the virtual screen to said consultation service terminal.

2. The consultation service system according to claim 1, wherein said server creates the virtual screen by incorporating the consultation subject screen into the virtual screen, and also by using the link data table to retrieve from a database auxiliary information which is linked to the data comprised in the consultation subject screen and incorporating the retrieved auxiliary information into the virtual screen.

3. The consultation service system according to claim 1, wherein said server displays the consultation subject screen and the auxiliary information divided between separate application screens.

4. The consultation service system according to claim 1, wherein a display of said consultation service terminal comprises a customer display unit disposed to be viewable from a customer side and a counselor side, and a counselor display unit disposed to be viewable from the counselor side but not from the customer side,
said server incorporating the retrieved auxiliary information into the virtual screen such that the retrieved auxiliary information is displayed on the counselor display unit.

5. The consultation service system according to claim 1, wherein said server is capable of outputting an image of said virtual screen to a consultation service support terminal for supporting a consultation service with a customer, which is connected to said server via a communication network.

6. A server which is connected via a communication network to a consultation service terminal for performing a consultation service with a customer and a consultation service support terminal for supporting a consultation service with a customer,
wherein said server stores an application that can be operated by both said consultation service terminal and said consultation service support terminal, and executes said application on the basis of an operation performed on said consultation service terminal or said consultation service support terminal, and
said server uses a link data table for linking data comprised in a consultation subject screen which corresponds to the consultation subject of the customer with auxiliary information for assisting the consultation service in order to create a virtual screen comprising the consultation subject screen and auxiliary information, and outputs an image of the virtual screen to said consultation service terminal or said consultation service support terminal.

7. A consultation service terminal for performing a consultation service with a customer while the customer and a counselor on a service provider side converse by displaying on a display a consultation subject screen corresponding to the consultation subject of the customer,
wherein, after the consultation subject screen is displayed, a link data table for linking data comprised in the consultation subject screen, which is prepared in advance, with auxiliary information for assisting the consultation service is used to retrieve from a database the auxiliary information that is linked to the data comprised in the consultation subject screen, whereupon said auxiliary information is displayed.

8. The consultation service terminal according to claim 7, wherein said display comprises a customer display unit disposed to be viewable from a customer side and a counselor side, and a counselor display unit disposed to be viewable from the counselor side but not from the customer side,
said auxiliary information being displayed on said counselor display unit.

9. A computer-readable medium having software for performing, on a computer which is connected via a communication network to a consultation service terminal for performing a consultation service with a customer and a consultation service support terminal for supporting a consultation service with a customer, and which stores an application that can be operated by both said consultation service terminal and said consultation service support terminal, a method of executing said application on the basis of an operation performed on said consultation service terminal or said consultation service support terminal, and a method of using a link data table for linking data comprised in a consultation subject screen which corresponds to the consultation subject of the customer with auxiliary information for assisting the consultation service in order to create a virtual screen comprising the consultation subject screen and auxiliary information, and outputting an image of the virtual screen to said consultation service terminal or said consultation service support terminal.

10. A computer-readable medium having software for performing, on a computer for performing a consultation service with a customer while the customer and a counselor on a service provider side converse by displaying on a display a consultation subject screen corresponding to the consultation subject of the customer, a method, performed after the consultation subject screen is diplayed, of using a link data table for linking data comprised in the consultation subject screen, which is prepared in advance, with auxiliary information for assisting the consultation service in order to retrieve from a database the auxiliary information that is linked to the data comprised in the consultation subject screen, and displaying said auxiliary information.
